(19) United States
(12) Patent Application Publication
(10) Pub. No.: US 2018/0052773 A1
(43) Pub. Date: Feb. 22, 2018

(54) MEMORY MANAGING METHOD AND APPARATUS ASSOCIATED WITH CACHE IN IMAGE PROCESSING SYSTEM

(71) Applicant: MStar Semiconductor, Inc., Hsinchu Hsien (TW)

(72) Inventor: He-Yuan Lin, Zhubei City (TW)

(21) Appl. No.: 15/428,437

(22) Filed: Feb. 9, 2017

(30) Foreign Application Priority Data
Aug. 19, 2016 (TW) 105126584

(51) Int. Cl. G06F 12/0864

(52) U.S. Cl. CPC G06F 12/0864; G06F 2212/401; G06F 2212/455; G06F 2212/608

(57) ABSTRACT

A memory managing method for a cache including multiple storage regions is provided. Each of the storage regions includes multiple cache lines, and corresponds to multiple image blocks included in an original image frame. In response to a request for storing compressed data of an image block into the cache, a target storage region corresponding to the image block is selected from the multiple storage regions. A target applied sequence of the cache lines for the image block is determined. The compressed data of the image block is stored into the target storage region in a way that the compressed data of the image block is stored in the target storage region as conformed to the target applied sequence of the cache lines.

This application claims the benefit of Taiwan application Serial No. 105126584, filed Aug. 19, 2016, the subject matter of which is incorporated herein by reference.

### BACKGROUND OF THE INVENTION

### Field of the Invention

The invention relates in general to a memory, and more particularly to a technology for managing a cache for storing image data.

### Description of the Related Art

In an electronic system, a cache is for temporarily storing a small amount of data that has been recently used or may be later used. Compared to a main memory having a larger capacity, the cache has a faster data access speed and however a higher cost. In general, a main memory is implemented by a dynamic random access memory (DRAM), and a cache is implemented by a static random access memory (SRAM). When a certain set of data is required, a processor first looks for the data from the cache, and only turns to search for the data from the main memory if the data is not found in the cache. Successfully finding target data from the cache is referred to a cache hit, and a failure to do so is referred to as a cache miss.

A cache includes multiple cache lines. Due to the limited capacity of a cache, one cache line is usually shared by multiple sets of data. Taking a dynamic image process for example, one image frame to be processed is often divided into multiple same-sized image blocks. When the capacity of a cache is insufficient for simultaneously storing all of the image blocks, each storage region (including one or more cache lines) in the cache is then designed to correspond to multiple image blocks. In practice, commonly based on a relative position of an image block in an image frame, a storage region for storing the image block in the cache is determined. For example, image blocks with starting coordinates having a common point (e.g., last five bits of the x-coordinate are 00000) correspond to a same storage region in a cache. Assume that two image blocks A and B both correspond to the same storage region in a cache. If the image block A is first captured and stored in the cache, data of the image block A is overwritten when a processor writes data of the image block B into the storage region, and vice versa.

To save the bandwidth required for accessing data from a cache, in a current approach, a simple compression process is first performed on the image data, and the compressed image data is then stored into the cache. If a non-compressed image block needs a space of eight cache lines, the number of cache lines needed for storing the corresponding compressed image block is naturally smaller than or equal to eight. In practice, considering different compression rates of image blocks, a storage space of eight cache lines is usually reserved in a cache for each image block.

FIG. 1(A) shows a schematic diagram of a storage region including eight cache lines. FIG. 1(B) and FIG. 1(C) show examples of correspondence of respective compressed data of image blocks A and B and a storage region 100. As shown in FIG. 1(B), assume that the compressed data of the image block A is first stored in the storage region 100, and occupies 50% of the space (four cache lines) of the storage region 100. As shown in FIG. 1(C), in response to a request of storing the image block B into the cache, the compressed data of the image block is stored into the storage region 100, and occupies 75% of the space (six cache lines) of the storage region 100. Based on current cache management approaches, regardless of a high or low compression rate of an image block, data stored into the storage region 100 is all stored starting from the same position (indicated by an arrow 110 in the diagram). Thus, the compressed data of the image block B later stored overwrites all of the compressed data of the image block A stored in the first cache lines of the storage region 100. In the above situation, a total cache miss is generated if the processor searches for the image block A from the cache, and the processor is then required to again retrieve the entire image block A from a main memory.

Assume that the compressed data of the image block A is later again written into the storage region 100. As shown in FIG. 1(D), the compressed data of the image block A overwrites only a part of (the first four cache lines) of the compressed data of the image block B, whereas the remaining part (the last two cache lines) of the compressed data of the image block B is preserved in the storage region 100. In the above situation, if the processor searches for the image block B from the cache, a result obtained includes a cache miss for the first four cache lines and a cache hit for the last two cache lines. That is to say, the processor merely needs to again retrieve the image data corresponding to the first four cache lines from the main memory for the image block B. It is seen that, in average, compared to non-compressed data, compressing an image block is capable of slightly increasing the rate of cache hit.

However, it is also seen from FIG. 1(A) to FIG. 1(D) that, when the image blocks are compressed, the cache lines in the storage region that are closer to the arrow 110 are more frequently used, as opposed to cache lines farther away from the arrow that are less frequently used. Such uneven utilization implies that a part of the hardware resources are not fully exercised.

### SUMMARY OF THE INVENTION

To solve the above issues, the present invention provides a memory managing method and a memory managing apparatus. By adopting different applied sequences of cache lines for different image block, the managing method and managing apparatus of the present invention are capable of more evenly utilize all of the cache lines, which is beneficial for efficiently utilizing hardware resources. In addition, the managing method and managing apparatus of the present invention are capable of further enhancing the rate of cache hit.

According to an embodiment of the present invention, a memory managing method applied to a cache including a plurality of storage regions is provided. Each of the storage regions includes a plurality of cache lines and corresponds to a plurality of image blocks included in an original image frame. In response to a request for storing compressed data of an image block into the cache, a target storage region corresponding to the image block is selected from the plurality of storage region. A target applied sequence of the cache lines for the image block is determined. The compressed data of the image block is stored in the target storage region as conformed to the target applied sequence of the cache lines.

According to another embodiment of the present invention, a memory managing apparatus applied to a cache including a plurality of storage regions is provided. Each of the storage regions includes a plurality of cache lines and corresponds to a plurality of image blocks included in an original image frame. The memory managing apparatus includes a region selecting circuit, an applied sequence determining circuit and a controller. In response to a request for storing compressed data of an image block into the cache, the region selecting circuit selects a storage region corresponding to the image block from the plurality of storage regions as a target storage region. The applied sequence determining circuit determines a target applied sequence of the cache lines for the image block. The controller stores the compressed data of the image block in the target storage region as conformed to the target applied sequence of the cache lines.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1(A) to FIG. 1(D) (prior art) are examples of correspondence between respective compressed data of two image blocks sequentially stored into a same storage region of a cache;

FIG. 2 is a flowchart of a memory managing method according to an embodiment of the present invention;

FIG. 3 is an example of an internal configuration of a cache applied to a memory managing method according to an embodiment of the present invention;

FIG. 4(A) is an example of an original image frame divided into multiple image blocks; FIG. 4(B) is an example of mapping between image blocks and storage spaces;

FIG. 5 illustrates an applied sequence of cache lines;

FIG. 6 is an example of mapping between image block positions and an applied sequence of cache lines;

FIG. 7(A) to FIG. 7(C) are examples of respective compressed data of two image blocks sequentially stored into a same storage region;

FIG. 8 is a flowchart with two steps exchanged according to another embodiment;

FIG. 9(A) to FIG. 9(C) are several examples of mapping between addresses of data to be stored and cache lines;

FIG. 10 is a detailed process of a memory managing method according to an embodiment of the present invention;

FIG. 11 is a flowchart of a memory managing method according to another embodiment of the present invention; and

FIG. 12 is a block diagram of a memory managing apparatus according to an embodiment of the present invention.

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

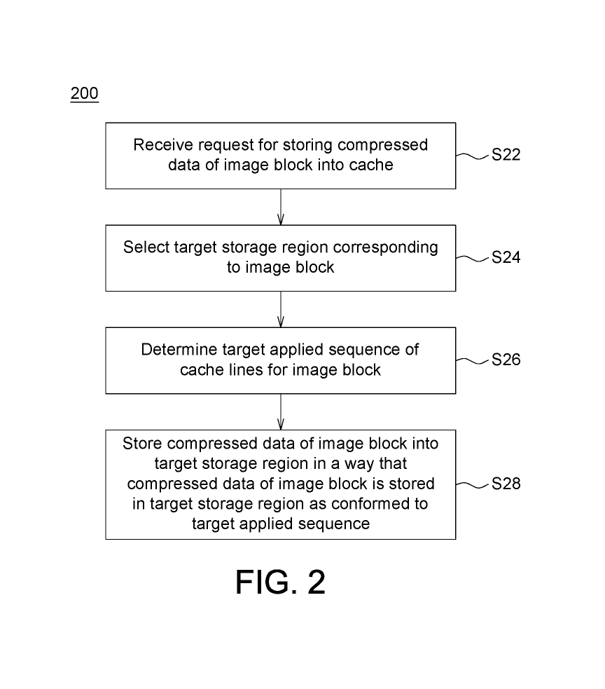

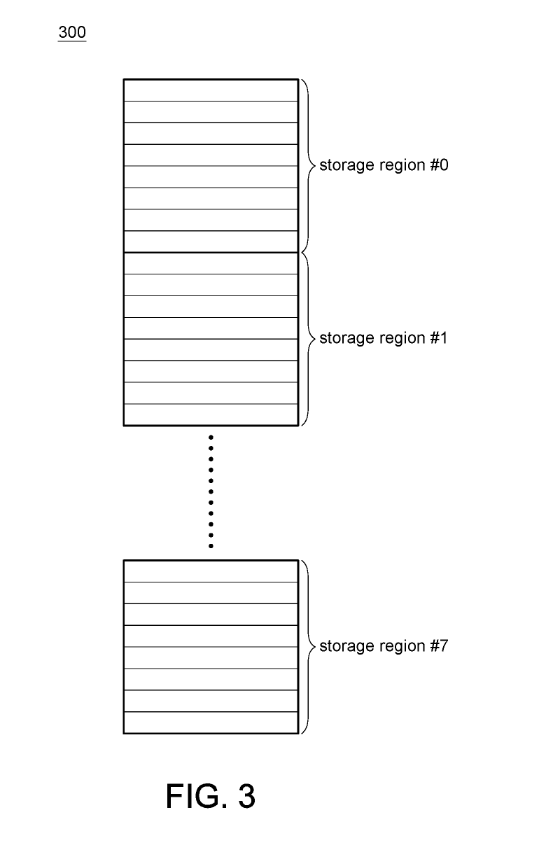

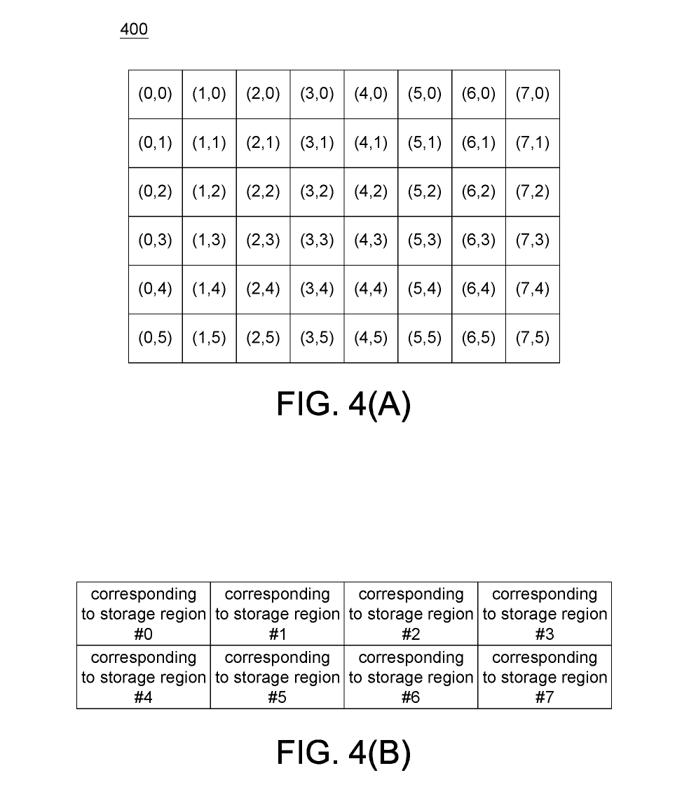

According to an embodiment of the present invention, a memory managing method for a cache including multiple storage regions is provided. FIG. 2 shows a flowchart of the memory managing method. FIG. 3 shows an example of an internal configuration of a cache applied to the memory managing method 200 of the present invention. A cache 300 includes 64 cache lines. Assume that a data size of compressed data of each image block occupies a storage space of 8 cache lines at most. The cache 300 may be planned to include 8 storage regions, each including 8 cache lines. In the embodiment, the 8 storage regions are numbered as a storage region #0 to a storage region #7, respectively. Taking an original image frame including 48 image blocks in FIG. 4(A) for example, each storage region in the cache 300 may be designed to correspond to 6 (=48/8) image blocks of the original image frame 400. In practice, the mapping between image blocks and storage regions may be determined by a circuit designer based on various application conditions (e.g., cache capacity, or the size of an original image frame), or may even be dynamically adjusted.

In one embodiment, a position of an image block serves as a basis for designation its corresponding storage region. In FIG. 4(B), 4*2 image blocks are taken as a unit, to show an example of mapping rules of image blocks and storage regions. More specifically, an original image frame 400 is divided into multiple sub image frames, each formed by 4*2 image blocks. In each sub image frame, the first image block at the first row is designated with correspond to the storage region #0, the second image block at the first row is designated with correspond to the storage region #1, . . . and so forth. By applying the mapping rules in FIG. 4(B) to the original image frame 400, it is divided into six sub image frames, and image blocks (0, 0), (4, 0), (0, 2), (4, 0), (0, 4) and (4, 4) are designated to the storage region #0. Once a request for storing the compressed data of any of the above stated image blocks ((0, 0), (4, 0), (0, 2), (4, 0), (0, 4) and (4, 4)) arises, the compressed data of the image block is stored into the storage region #0. Similarly, image blocks (1, 0), (5, 0), (1, 2), (5, 2), (1, 4), and (5, 4) are designated to correspond to the storage region #1; the image blocks (0, 1), (4, 1), (0, 3), (4, 3), (0, 5) and (4, 5) are designated to correspond to the storage region #5; and so forth.

To better illustrate the concept of the present invention, in the embodiments below, the memory managing method 200 is described with the assumptions of FIG. 3, FIG. 4(A) and FIG. 4(B). However, one person skilled in the art can understand that the scope of the present invention is not limited to any of the assumptions.

In step S22, a request for storing compressed data of an image block into the cache 300 is received. In response to the request, in step S24, a storage region corresponding to the image block is selected from the storage region #0 to the storage region #7. In practice, the mapping between the image blocks and storage regions is usually known information. In the example in FIG. 4(A) and FIG. 4(B), assume that the request received in step S22 is storing the compressed data of the image block (0, 0) into the cache 300. According to position information of the image block (0, 0), in step S24 it may select the corresponding storage region #0 as the target storage region, from the storage region #0˜#7. In step S26, an applied sequence of the cache lines for the image block (0, 0) is determined as a target applied sequence. In step S28, the compressed data of the image block (0, 0) is stored into the target storage region as conforming to the target applied sequence selected in step S26.

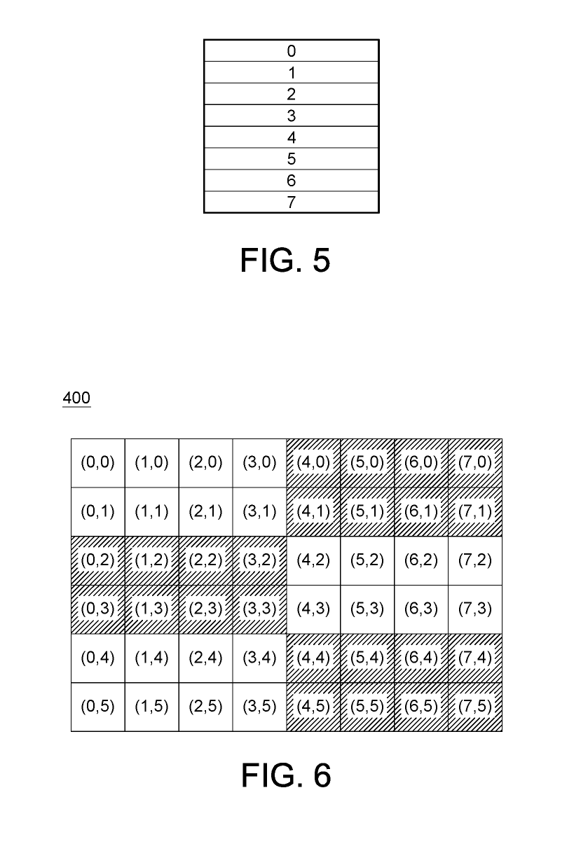

The 8 cache lines of the storage region #0 are re-depicted in FIG. 5 and numbered 0 to 7 to illustrate an applied sequence of the cache lines. In the embodiment below, each cache line has been given a number, where one number of certain cache line which appears earlier in the sequence has a higher priority to be applied. For an applied sequence 01234567, the cache line 0 has a higher priority to be applied than that of the cache line 1, the priority of the cache line 1 is higher than that of the cache line 2, . . . , and the priority of the cache line 6 is higher than that of the cache line 7. For example, assume that the compressed data of the image block (0, 0) requires 4 cache lines, and the applied sequence selected for the compressed data of the image block (0, 0) is 01234567 in step S26. Thus, in step S28, the compressed data of the image block (0, 0) is stored into the storage region #0, in the cache line 0 to the cache line 3, of higher priority in that applied sequence.

It should be noted that, the applied sequence of the cache lines is not necessarily the same as a sequence for storing data. Please refer to the above example where the cache lines 0˜3 in the storage region #0 have higher priorities than cache lines 4˜7 because 4 cache lines are required. However, the compressed data of the image block (0, 0) may not be stored into the cache line 0˜3 in sequence; instead, it may be stored into the cache line 3 firstly, then the cache line 2, the cache line 1 and the cache line 0, for example. As long as the cache lines 0˜3 are applied to store the compressed data of the image block (0,0) prior to other cache lines in the applied sequence, it achieves the inventive results.

In one preferred embodiment, in step S26, two applied sequences of the cache lines are applicable, respectively referred to as a first applied sequence and a second applied sequence. The first applied sequence is totally opposite in order to the second applied sequence. For example, if the first applied sequence is 01234567, the second applied sequence is then 76543210. Alternatively, when the first applied sequence is 02451357, the second applied sequence is then 75316420.

In one embodiment, a mapping rule is predetermined. The mapping rule describes the correlation between image block positions and a plurality of predetermined applied sequences of the cache lines. FIG. 6 shows an example of mapping between image block positions and the applied sequences. As shown in FIG. 6, when an image block falls in the white, non-shaded area in the original image frame 400, the compressed data of that image block is designated with the first applied sequence. In contrast, if the non-compressed data of the image block falls in a shaded area in the original image frame 400, the compressed data of the image block is designated with the second applied sequence. Under the above assumption, in step S26 the applied sequence of cache lines is selected according to the position information of the image block and the mapping rule. For example, in step S26 the first applied sequence is selected for the image block (0, 0) that falls in the white area, the second applied sequence is selected for the image block (4, 0) that falls in the shaded area, and so forth.

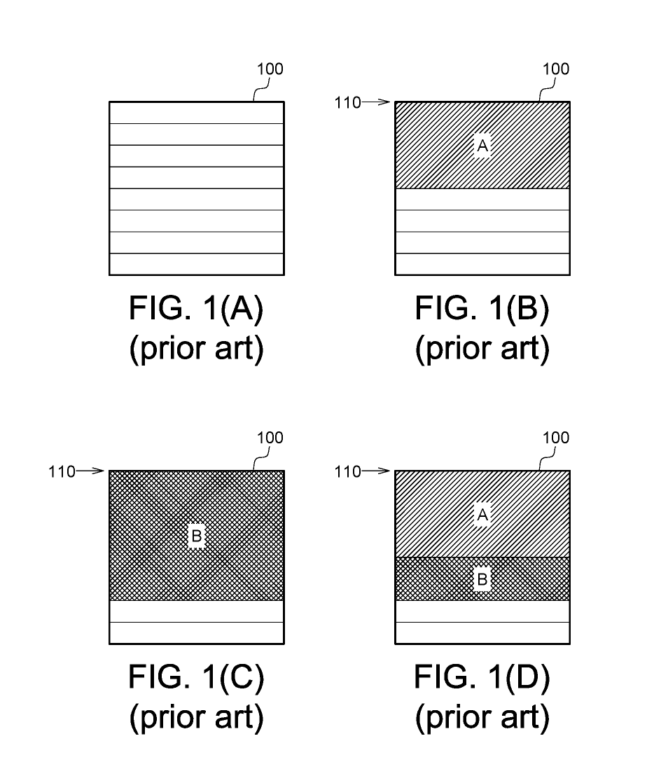

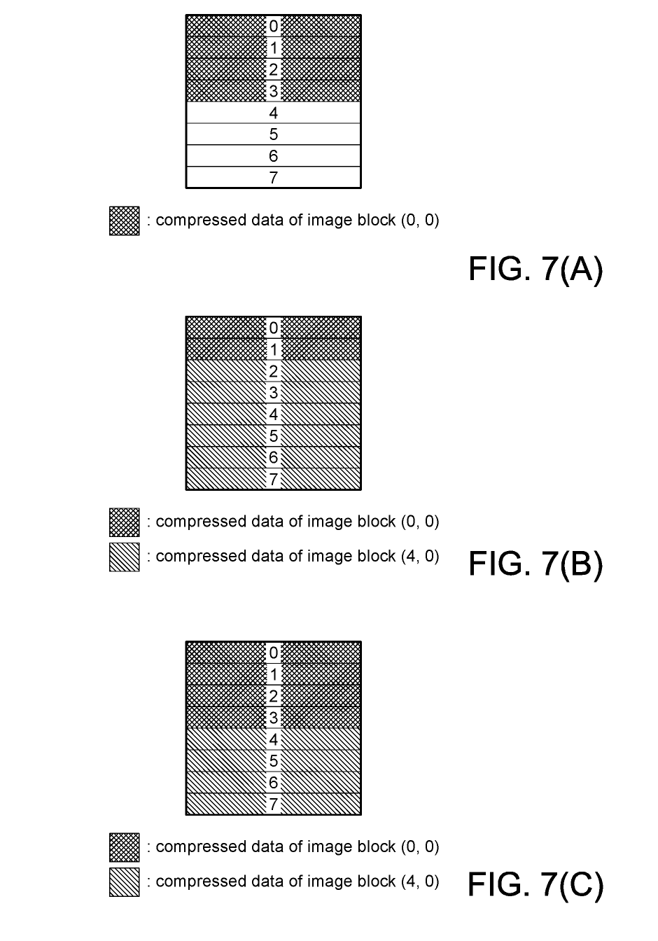

Assume that the first applied sequence is 01234567, the second applied sequence is 76543210. The compressed data of the image block (0, 0) requires 4 cache lines to store, and the compressed data of the image block (4, 0) requires 6 cache lines to store. FIG. 7(A) shows an example of distribution of the data in the storage region #0 when the compressed data of the image block (0, 0) is first stored into the storage region #0. Next, if it is requested that the compressed data of the image block (4, 0) be stored into the cache 300, as the applied sequence designated to the compressed data of the image block (4, 0) is 76543210, a controller of the cache 300 would stores the compressed data of the image block (4, 0) into the 6 cache lines, i.e., cache line 7, the cache line 6, the cache line 5, the cache line 4, the cache line 3, and the cache line 2, of the storage region #0. As shown in FIG. 7(B), the part of the compressed data of the image block (4, 0) stored in cache line 2 and 3 overwrites the part of the compressed data of the image block (0, 0) originally stored in the cache line 2 and the cache line 3, whereas the part of the compressed data of the image block (0, 0) stored in the cache line 1 and the cache line 0 is preserved therein. Different from the situation shown in FIG. 1(B) where the compressed data of the image B overwrites all the compressed data of the image block A, the instant cache 300 of the present invention avoids complete cache miss for a compressed data of certain image block. In contrast, the processor only needs to retrieve the data corresponding to the cache line 2 and the cache 3 from the main memory for the image block (0, 0).

FIG. 7(C) shows a result when the compressed data of the image block (0, 0) is later again written into the cache 300. While the compressed data of the image block (4, 0) originally stored at the cache line 2 and the cache line 3 is overwritten, the part of the compressed data of the image block (4, 0) stored in the cache line 4 to the cache line 7 is still available. At this point, the compressed data of the image block (4, 0) would not be totally missed, and only the data corresponding to the cache line 2 and the cache line 3 needs to be again retrieved from the main memory for the image block (4, 0). It is seen from comparing FIG. 1(C) with FIG. 7(C), as opposed to the prior art, the memory managing method 200 in average provides a higher rate of cache hit.

Known from the above example, because the image blocks (0, 0) and the image block (4, 0) are designated with different applied sequences, the controller of the cache 300 does not store the two sets of data from the same position. In practice, through appropriately designing the applied sequences of cache lines, the cache lines are more evenly utilized, hence eliminating the issue of not fully exercising hardware resources as in the prior art.

In many image processes, two image blocks located at positions close to one other in an original image frame have a higher probability of being sequentially stored into a cache within a short period of time. For example, in a short period of time after the compressed data of the image block (0, 0) is stored into the storage region #0, it is more possible that the compressed data of the image block (4, 0) or the compressed data of the image block (0, 2) is stored into the storage region #0 than the compressed data of the image block (4, 2) is stored into the storage region #0. A principle for designating applied sequences of the cache lines may be determined based on the above characteristic. That is to say, for multiple image blocks corresponding to the same storage region, the applied sequence designated to one image block is different from the applied sequence designated to another image block closest to the image block in the horizontal direction, and is different from the applied sequence designated to another image block closest to the image block in the vertical direction. Referring to FIG. 6, among the multiple image blocks corresponding to the same storage region #0, the image block (4, 0) is closest to the image block (0, 0) in the horizontal direction, and the image block (0, 2) is closest to the image block (0, 0) in the vertical direction. Thus, when the compressed data of the image block (0, 0) is designated with the first applied sequence, the compressed data of the image block (4, 0) and that of the image block (0, 2) may be designated with the second applied sequence. Similarly, among the multiple image blocks corresponding to the same image region #2, the image block (6, 2) is closest to the image block (2, 2) in the horizontal direction, and the image block (2, 0) and the image block (2, 4) are closest to the image block (2, 2) in the vertical direction. Thus, when the compressed data of the image block (2, 2) is designated with the second applied sequence, the compressed data of the image blocks (6, 2), (2, 0) and (2, 4) may be designated with the first applied sequence, and so forth.

Theoretically, the first applied sequence may and the second applied sequence may be completely opposite in order to optimize magnitude maximization. The present invention is not limit thereto, however. In one embodiment, the first applied sequence is only partially opposite the second applied sequence. For example, if the first applied sequence is 01234567, the second applied sequence may be 32104567 or 01237654. One person skilled in the art can understand that, given that the first applied sequence and the second applied sequence are not entirely the same (e.g., completely opposite, partially opposite or cyclically shifted), the average rate of cache hit of the memory managing method 200 is higher than that of the prior art that adopts the same applied sequence of cache lines. According to an embodiment of the present invention, the two applied sequences even need not be partially opposite. For example, if the first applied sequence is 01234567, the second applied sequence may be 12345670.

Further, one person skilled in the art can understand that, it is not necessary that the cache lines 0 to 7 in each of the storage regions be configured as adjacent to one another in an actual memory circuit, or limited to being arranged according to a specific order, and these denotations are merely used for setting the applied sequences.

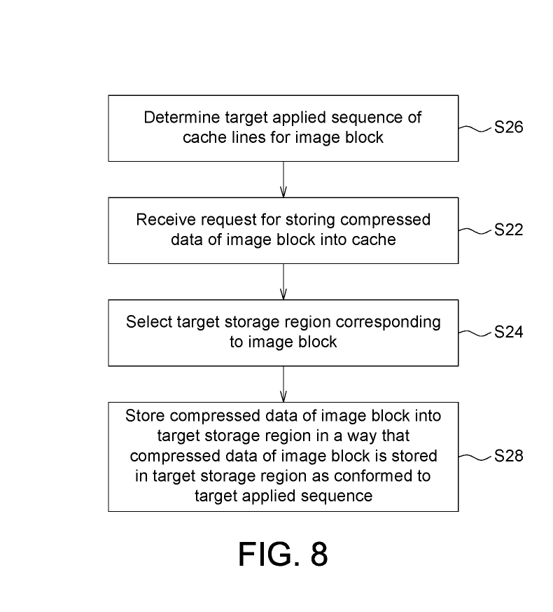

In practice, if step S24 and step S26 both use the position information of image blocks as the basis for selection, these two steps may be performed concurrently or performed in reverse order. That is to say, in a situation where the target storage region is unknown, the target applied sequence may also be determined for each of the image blocks. FIG. 8 shows a flowchart of step S26 being earlier than step S22.

In another embodiment, step S26 determines the applied sequence designation to the compressed data of the current image block according to a previous applied sequence (instead of the position information of the image block), and a designation principle is to choose a current applied sequence different from the previous applied sequence. The so-called previous applied sequence refers to the applied sequence adopted in step S24 for previously storing of the compressed data of another image block into the target storage region. For example, assume that the compressed data of the image block (0, 0) is stored into the storage region #0 according to the first applied sequence, and is followed by a request for storing the compressed data of the image block (4, 2) into the cache 300. The compressed data of the image block (4, 2) also corresponds to the storage region #0. Because the compressed data of the image block (0, 0) originally stored in the storage region #0 is stored according to the first applied sequence, step S26 selects the second applied sequence that is different from the first applied sequence to store the compressed data of the image block (4, 2).

In practice, The previous applied sequence may be recorded in a memory space or register outside or inside the cache 300. Further, step S26 may select an applied sequence different from the previous applied sequence from a plurality of predetermined applied sequences of the cache lines as the target applied sequence. Alternatively, step S26 may also immediately determine an applied sequence different from the previous applied sequence without referring to any predetermined applied sequences.

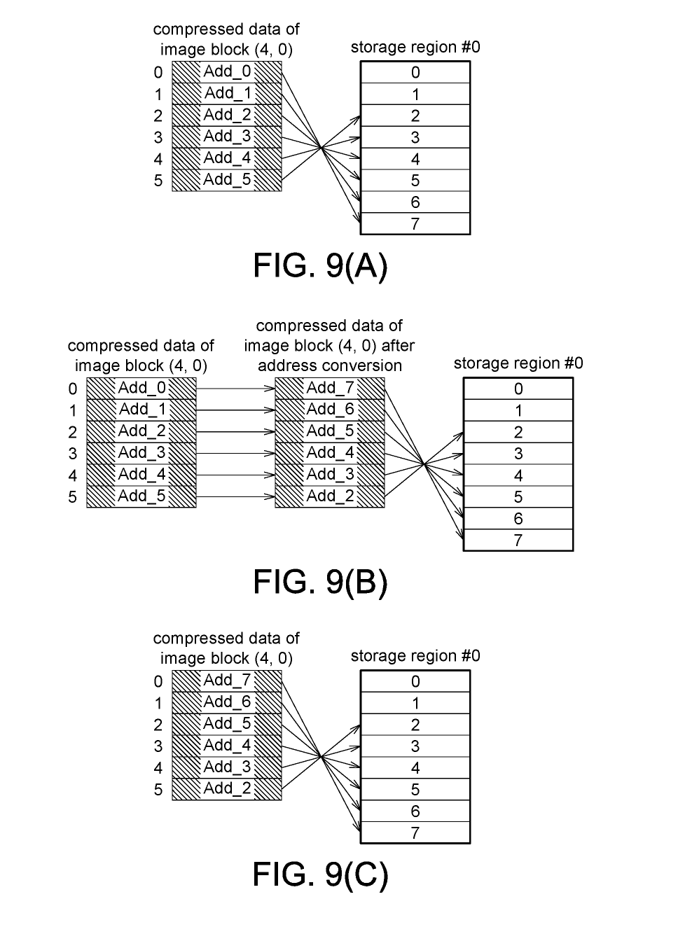

Step 28 can be implemented in different ways, as long as “causing the compressed data of image blocks to conform to a target applied sequence of the cache lines” is achieved, it is encompassed within the scope of the present invention. In one embodiment, the cache 300 does not adopt a fixed mapping between data address and cache number. More specifically, without considering one or multiple data addresses of compressed data, the controller of the cache 300 may store the compressed data of an image block into the target storage region according to the target applied sequence of the cache lines. As shown by the example in FIG. 9(A), the controller of the cache 300 may directly sequentially write the data of the compressed data of the image block (4, 0) at the addresses Add_0 to Add_5 into the cache lines numbered 7 to 2 in the storage region #0 according to the applied sequence 76543210.

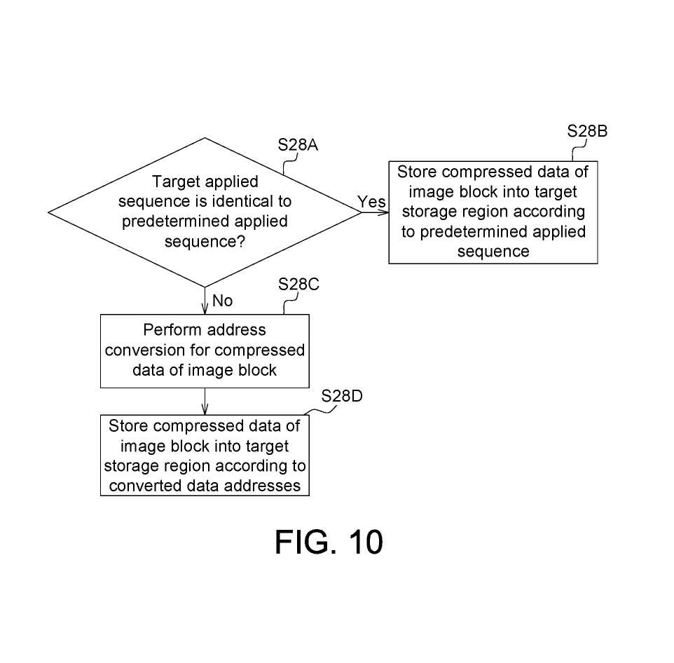

The controller of some caches determines where in a target storage region the data is to be stored according to position information of the data to be stored. In other words, some caches adopt a fixed mapping between data address/cache line number. In the above situation, changing addresses of data to be stored can achieve the result of changing the applied sequence. FIG. 10 shows a detailed example of step S28. In step S28A, it is determined whether a target applied sequence selected in step S26 is identical to a predetermined applied sequence (e.g., 01234567) of the cache 300. When the determination result of step S28A is affirmative, step S28B is performed to store the compressed data of the image block into the target storage region according to the predetermined applied sequence. When the determination result of step S28A is negative, step S28C is performed to perform an address conversion process for the compressed data of the image block according to the target applied sequence to generate one or multiple converted data addresses. In step S28D, according to the one or multiple converted data addresses, the compressed data of the image block is stored into the target storage region. Details of Step S28A to step S28D are given in an operation example below.

Assume that the controller of the cache 300 is designed to write the data to be stored into a cache line having the same number and address, and the applied sequence that step S26 designates to the compressed data of the image block (4, 0) is 76543210. Without the address conversion, the data at the address Add_0 in the compressed data of the image block is written into the cache line numbered 0 in the storage region #0, the data at the address Add_1 is written into the cache line numbered 1, and so forth. As shown in FIG. 9(B), after the address conversion is performed according to the target applied sequence 76543210, the data originally at the address Add_0 is modified to having the address Add_7, the data originally at the address Add_1 is modified to have the address Add_6, . . . , and the data originally at the address Add_5 is modified to have the address Add_2. Thus, the controller of the cache 300 may maintain an operation mode of “storing data to a cache line having the same number and address”, while causing the compressed data of the image block to be stored into the target stored region as conforming to the target applied sequence. In practice, the address conversion may be performed by the controller in the cache 300, or may be performed by another processor outside the cache 300.

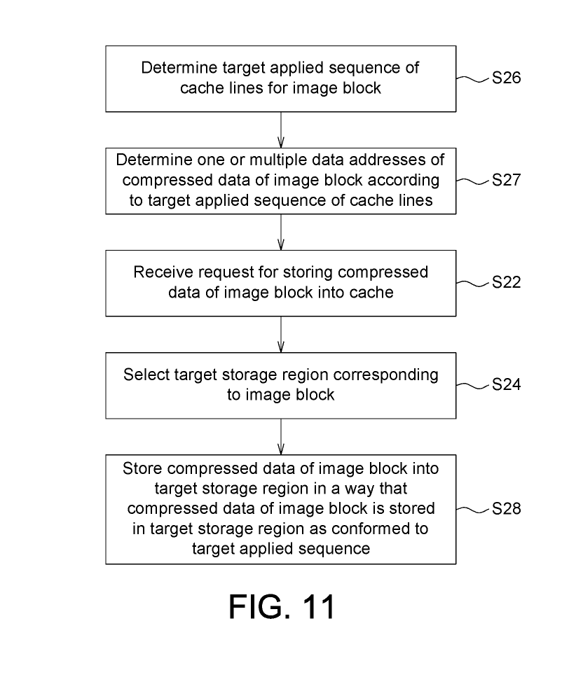

As previously described, step S26 may be performed earlier than step S22. FIG. 11 shows a flowchart of a memory managing method according to another embodiment of the present invention. In this embodiment, step S27 is further provided between step S26 and step S22. In step S27, one or multiple data addresses of the image block are determined according to the target applied sequence. Referring to FIG. 9(C) showing an operation example of this process, given that the applied sequence 76543210 designated to the compressed data of the image block (4, 0) is known, the data in the compressed data of the image block, after having been compressed, is directly assigned to have fixed addresses Add_7 to Add_2 through an appropriate addressing method. Thus, when the cache 300 is designed to fixedly write data to be stored to a cache line having the same number and address, the compressed data of the image block (4, 0) is stored into the storage region #0 as conforming to the target applied sequence.

In practice, step S26 and step S27 in FIG. 11 may be performed before the request for storing data into a cache arises. For example, before storing data into the cache 300, the data in the compressed data of the image block (4, 0) may be stored in a main memory (not shown) according to the address designated in step S27B.

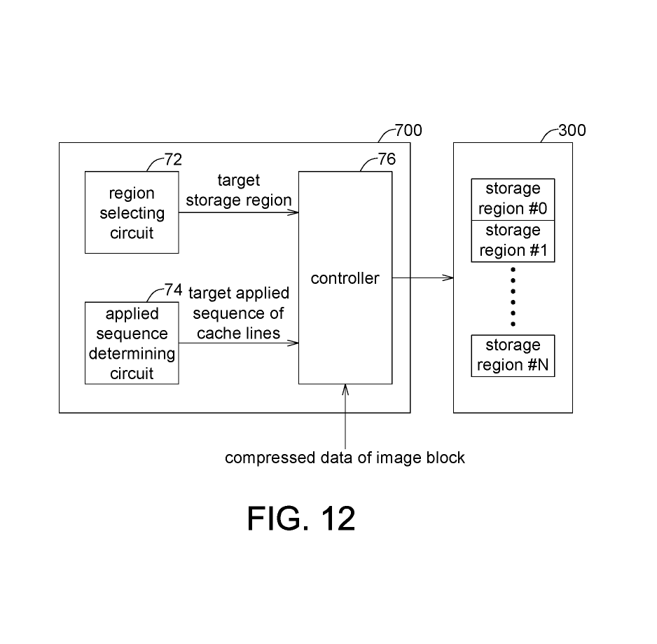

A memory managing apparatus is provided according to another embodiment of the present invention. FIG. 12 shows a functional block diagram of the memory managing apparatus. A memory managing apparatus 700 is applied to the cache 300 including multiple storage regions, each including a plurality of cache lines and corresponding to a plurality of image blocks included in an original image frame. The memory managing apparatus 700 includes a region selecting circuit 72, an applied sequence determining circuit 74 and a controller 76. The region selecting circuit 72 receives a request, which is associated with storing compressed data of an image block into the cache. In response to the request, the region selecting circuit 72 selects a target storage region corresponding to the image block from the multiple storage regions. The applied sequence determining circuit 74 determines a target applied sequence for the image block. The controller 76 stores the compressed data of the image block in the target storage region, in a way that the compressed data of the image block is stored in the target storage region as conformed to the target applied sequence.

In practice, the memory managing apparatus 700 may be realized by numerous control and processing platforms, including fixed and programmable logic circuits, e.g., programmable logic gate arrays, application-specific integrated circuits (ASIC), microcontroller, microprocessors, and digital signal processors (DSP). Further, the memory managing apparatus 700 may also be designed to perform an associated task through executing a processor instruction stored in a memory. It should be noted that, the region selecting circuit 72, the applied sequence determining circuit 74 and the controller 76 may be integrated into the cache 300 or may be independent devices outside the cache 300.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A memory managing method, applied to a cache comprising a plurality of storage regions, each of the storage regions comprising a plurality of cache lines and corresponding to a plurality of image blocks in an original image frame, the memory managing method comprising:
a) receiving a request associated with storing compressed data of an image block into the cache;
b) in response to the request, selecting a target storage region corresponding to the image block from the plurality of storage regions;
c) determining a target applied sequence of the cache lines for the image block; and
d) storing the compressed data of the image block into the target storage region in a way that the compressed data of the image block is stored in the target storage region conformed to the target applied sequence of the cache lines.

2. The memory managing method according to claim 1, wherein a mapping rule is predetermined and describes correlation between positions of the image blocks and a plurality of predetermined applied sequences of the cache lines, and step (c) comprises:
obtaining position information of the image block, indicating a position of the image block in the original image frame; and
selecting the target applied sequence of the cache lines from the plurality of predetermined applied sequences of cache lines according to the position information and the mapping rule.

3. The memory managing method according to claim 2, wherein the plurality of image blocks corresponding to the target storage region comprise a first image block and the second image block; the second image block and the first image block are closest to each other in a predetermined direction among the plurality of image blocks; the mapping rule comprises designating a first applied sequence to the first image block, and designating a second applied sequence, different from the first applied sequence, to the second image block.

4. The memory managing method according to claim 3, wherein the first applied sequence and the second applied sequence are at least partially opposite in order.

5. The memory managing method according to claim 1, wherein step (c) comprises:
determining the target applied sequence of the cache lines according to a previous applied sequence in a way that the target applied sequence of the cache line is different from the previous applied sequence, wherein the previous applied sequence is adopted for previous storing of compressed data of another image block into the same target storage region.

6. The memory managing method according to claim 5, wherein step (c) comprises:
selecting an applied sequence different from the previous applied sequence among a plurality of predetermined applied sequences as the target applied sequence of the cache lines.

7. The memory managing method according to claim 5, wherein step (c) comprises:
causing the target applied sequence of the cache lines and the previous applied sequence to be to be at least partially opposite in order.

8. The memory managing method according to claim 1, wherein the cache does not adopt a fixed mapping of data address and cache line number, and step (d) comprises:
storing the compressed data of the image block into the plurality of cache lines within the target storage region according to the target applied sequence of the cache lines without considering one or a plurality of data addresses of the compressed data of the image block.

9. The memory managing method according to claim 1, wherein the cache adopts a fixed mapping of data address and cache line number, and step (d) comprises:
converting one or a plurality of data addresses according to the target applied sequence of the cache lines to generate one or a plurality of converted data addresses; and
storing the compressed data of the image block into the plurality of cache lines within the target storage region according to the one or plurality of converted data addresses.

10. The memory managing method according to claim 1, wherein the cache adopts a fixed mapping of data address and cache line number, and step (c) is performed earlier than step (a); between step (c) and step (a), the memory managing method further comprising:
determining one or a plurality of data addresses of the compressed data of the image block according to the target applied sequences.

11. A memory managing apparatus, applied to a cache comprising a plurality of storage regions, each of the storage regions comprising a plurality of cache lines and corresponding to a plurality of image blocks in an original image frame, the memory managing apparatus comprising:
a region selecting circuit, receiving a request associated with storing compressed data of an image block into the cache, selecting a target storage region corresponding to the image block from the plurality of storage regions in response to the request;
an applied sequence determining circuit, determining a target applied sequence of the cache lines for the image block; and
a controller, storing the compressed data of the image block into the target storage region, in a way that the compressed data of the image block is stored as conformed to the target applied sequence of the cache lines.

12. The memory managing apparatus according to claim 11, wherein a mapping rule is predetermined and describes correlation between positions of the image block and a plurality of predetermined applied sequences of the cache lines, the applied sequence determining circuit selects the target applied sequence from a plurality of predetermined applied sequences of cache lines according to position information of the image block and the mapping rule, and the position information indicates a position of the image block in the original image frame.

13. The memory managing apparatus according to claim 12, wherein the plurality of image blocks corresponding to the target storage region comprise a first image block and the second image block; the second image block and the first image block are closest to each other in a predetermined direction among the plurality of image blocks; the mapping rule comprises designating a first applied sequence to the first image block, and designating a second applied sequence, different from the first applied sequence, to the second image block.

14. The memory managing apparatus according to claim 13, wherein the first applied sequence and the second applied sequence are at least partially opposite in order.

15. The memory managing apparatus according to claim 11, wherein the applied sequence determining circuit determines the target applied sequence of the cache lines according to a previous applied sequence in a way that the target applied sequence is different from the previous applied sequence, wherein the previous applied sequence is adopted for previous storing of compressed data of another image block into the same target storage region.

16. The memory managing apparatus according to claim 15, wherein the applied sequence determining circuit selects an applied sequence different from the previous applied sequence among a plurality of predetermined applied sequences as the target applied sequence of the cache lines.

17. The memory managing apparatus according to claim 15, wherein the applied sequence determining circuit causes the target applied sequence and the previous applied sequence to be at least partially opposite in order.

18. The memory managing apparatus according to claim 11, wherein the cache does not adopt a fixed mapping of data address and cache line number, and the controller stores the compressed data of the image block into the plurality of cache lines within in the target storage region according to the target applied sequence of the cache lines without considering one or a plurality of data addresses of the compressed data of the image block.

19. The memory managing apparatus according to claim 11, wherein the cache adopts a fixed mapping of data address and cache line number; the memory managing apparatus further comprising:
an address converting circuit, selectively converting one or a plurality of data addresses according to the target applied sequence of the cache lines to generate one or a plurality of converted data addresses;
wherein, the controller stores the compressed data of the image block into the plurality of cache lines within in the target storage region according to the one or plurality of converted data addresses.

20. The memory managing apparatus according to claim 11, wherein the cache adopts a fixed mapping of data address and cache line number; the memory managing apparatus further comprising:
an addressing circuit, determining one or a plurality of data addresses of the compressed data of the image block according to the target applied sequence.
